(19) United States
(12) Patent Application Publication
(10) Pub. No.: US 2003/0051506 A1
(43) Pub. Date: Mar. 20, 2003

(54) Method and apparatus for producing glass balls

(76) Inventors: Hatto Schafer, Nieder-Olm (DE); Christian Schenk, Ingelheim (DE); Horst Wolf, Heidesheim (DE); Andreas Walsdorf, Wiesbaden (DE)

Correspondence Address: Pauley Petersen Kinne & Erickson, Suite 365, 2800 W. Higgins Road, Hoffman Estates, IL, 60195, US

(21) Appl. No.: 10/192,767

(22) Filed: Jul. 10, 2002

(30) Foreign Application Priority Data
Jul. 13, 2001 (DE) 101 34 198.9

(51) Int. Cl. C03B 19/10; C03B 13/14

(52) U.S. Cl. 65/21.1; 65/66; 65/122; 65/143

(57) ABSTRACT

A method for producing glass balls, wherein a glass flow is fed between two rollers which are driven synchronously but counter-rotatingly in a flow direction, from a feed tank containing a mass of molten glass. The rollers have hemispherical depressions distributed over the circumference and form spherical beads on a thin glass strip successively in the region of an imaginary contact tangent. A thickness of the glass strip is fixed by the spacing between the rollers externally of the depressions in the region of the contact tangent. Crude balls are separated from the glass strip by a separating device, once the glass strip, containing the spherical beads, is cooled. The crude balls are subjected to a cold surface finishing treatment.

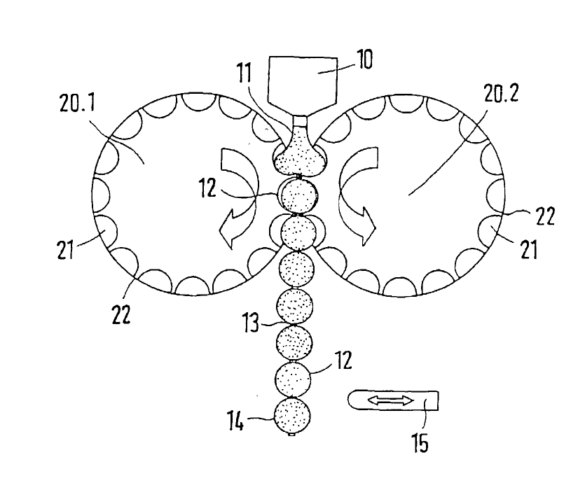

### BACKGROUND OF THE INVENTION

1. Field of the Invention

This invention relates to a method and an apparatus for producing glass balls.

2. Description of Related Art

Known methods for producing glass balls are complex and thus incur high production costs. It is known to cut manageable pieces or pellets from a glass block and then to round them and rough-grind them in a drum. The crude balls thus produced are ground coarsely, ground finely, lapped and polished, for example they are subjected to a plurality of cold finishing treatments. The same disadvantages also exist when cylindrical portions are separated from glass rods as initial components.

When producing the glass rods, constrictions are made which are shaped to form balls. The strand of glass may also be severed by air pressure or by a rotating disc, so that small glass particles are sprayed or centrifuged, the particles being shaped to form balls by surface tension. In such case, however, the size of the balls produced is limited to a diameter range less than 1 mm.

### SUMMARY OF THE INVENTION

One object of this invention is to provide a method of producing glass balls, whereby a plurality of crude balls, even those of a relatively large diameter, can be easily produced.

In the method according to this invention, a glass flow is fed between two rollers, which are driven synchronously but counter-rotatingly in the flow direction, from a feed tank containing a mass of molten glass. The rollers have hemispherically shaped depressions distributed over the circumference and form spherical beads on a thin glass strip successively in the region of an imaginary contact tangent. The thickness of the glass strip is fixed by the spacing between the rollers externally of the depressions in the region of the contact tangent. Crude balls are separated from the glass strip by a separating device once the glass strip, containing the spherical beads, is cooled. The crude balls are subjected to a cold surface finishing treatment.

The thin glass strip, containing the spherical beads, includes a plurality of crude balls which, after cooled, can easily be separated from the thin glass strip using a separating device because the thin glass strip is in the form of an intended breaking location. In such case, the separation may be effected in a drum.

In such case, it is important that the two rollers are driven synchronously and counter-rotatingly, and that the depressions are disposed on the roller casing so that they are constantly aligned with one another in the region of the imaginary contact tangent and form the spherical beads. It is necessary to prevent the depressions, which encounter one another, from becoming offset from one another on the circumferential side or axially, which can be achieved easily by driving the rollers in a correspondingly synchronously regulated manner. Because the crude balls are obtained at relatively low cost, additional operations prior to the cold finishing treatment are no longer necessary.

So that the crude balls can easily be separated from the glass strip, in one embodiment the glass strip, between the spherical beads, has intended breaking locations having a thickness of about 1.5 mm. Greater thicknesses no longer represent good intended breaking locations. In the case of smaller thicknesses, it is possible, during the separating process, for cracks to form in the region of the crude balls.

According to an additional embodiment, the rollers are heated-up to about 270 to 300° C. by radiation heat.

This method avoids differences in temperature which are too great between the rollers and the glass strip containing the beads, and cracks are prevented from forming in the glass.

In the case where types of glass have low viscosity (short η development curve), one pair of rollers is generally sufficient for the drawing system, because the solidifying process and a sufficiently thin rolling-out process are concluded at about the same time. In the case of more viscous glass types (longer η development curve), these two mechanisms are not achieved with one pair of rollers. A cascade of rollers, having 2 to 3 pairs of rollers, is provided.

So that the glass flow travels uniformly along the rollers and enters the depressions, in a further embodiment, the glass flow is supplied to the rollers from the feed tank with a temperature of between 1000 and 1200° C. and a low viscosity of between 1 and 50 dpas, preferably about 10 dpas, at a through flow rate of between 200 and 250 g/min. For glasses which are too viscous, the glass strip, or the intended breaking locations, cannot be rolled thinly enough.

So that the beads assume as good a spherical configuration as possible, the diameter of the rollers can be selected to be between 100 and 250 mm, and the radius of the depressions can be selected to be between 3 and 10 mm.

In order to optimize the roller circumference for the formation of beads, in one embodiment rollers are used, wherein the depressions are disposed in circumferential rows on the roller surfaces with uniform spacings therebetween, the adjacent circumferential rows being interleaved with each other so as to be offset from each other by half a spacing. Thus the glass strip, as the intended breaking location and carrier of the spherical beads, is limited to short lengths between the beads.

In an apparatus for producing glass balls according to the method of this invention, a glass flow can be supplied from a feed tank, containing a mass of molten glass, to a shaping device having two rollers, which are driven synchronously and counter-rotatingly and have hemispherical depressions to form a thin glass strip having spherical beads. Once the glass strip is cooled, the beads are separable from the glass strip as crude balls by using a separating device. The crude balls are then subjected to a cold surface finishing treatment, the final cold finishing treatment being accomplished in a known manner to the desired extent.

### BRIEF DESCRIPTION OF THE DRAWING

The method and the apparatus according to this invention are explained in more detail, with reference to one schematic drawing.

### DESCRIPTION OF PREFERRED EMBODIMENTS

The feed tank 10 of an apparatus may be, for example, the drawing container for a drawing system of a plate glass system. In the feed tank 10 the mass of molten glass is supplied to the two counter-rotatingly driven rollers 20.1 and 20.2 as glass flow 11 via an outlet slot.

The surfaces of the rollers 20.1 and 20.2 have circumferential rows of hemispherical depressions 21, which are disposed at uniform spacings from one another and are each separated from the other by circumferential regions 22 of the rollers 20.1 and 20.2. A gap, which determines the thickness of the glass strip 13 flowing therethrough, remains at the location with the smallest spacing between the rollers 20.1 and 20.2, which rotate in the flow direction of the glass flow 11, for example at the ideal contact tangent, while the depressions 21 of the two rollers 20.1 and 20.1, which encounter one another when aligned in this region, form spherical beads 12 in this glass strip 13. In such case, the depressions 21, which extend into the narrowest zone, are initially filled with the glass flow 11, which is compressed to form the beads 12 as it passes the location with the gap. The gap is selected to be between 1.3 and 1.5 mm, and the glass flow 11 is conveyed through the rollers 20.1 and 20.2 with a temperature of between 1000 and 1200° C. at a through flow rate of 200 to 250 g/min. In such case, a mass of molten glass is used, which has a low viscosity of between 1 and 50 dPas, preferably of 10 dPas, and reliably accomplishes the filling process of the depressions 21.

The rollers 20.1 and 20.2 have a diameter of between 100 and 200 mm, and the depressions 21 have a radius of between 3.5 and 6 mm, when glass balls with a diameter of between 7 and 12 mm are produced. In order to prevent cracks from being formed in the beads 12, the rollers 20.1 and 20.2 are heated-up to between 270 and 350° C. by radiation heat.

A plurality of circumferential rows of depressions 21 may be disposed in the axial direction, which are alternately offset from one another by half a spacing and interleaved with one another in order to obtain intended breaking locations which are as short as possible between the beads 12. The intended breaking locations are fixed by the thickness of the glass strip 13 and determined by the dimension of the gap between the rollers 20.1 and 20.2. Thus, the glass strip 13 between the beads 12 should not be too thick, and even the smallest value is critical in order to prevent cracks from being formed in the crude balls 14 during the subsequent breaking-off of the crude balls 14 from the glass strip 13. After the cooling and hardening of the glass strip 13, containing the beads 12, the separation process is accomplished with a separating device, such as a drum or respectively a hammer device.

The crude balls 14, thus obtained, are subjected to a cold surface finishing treatment, for which purpose a coarse-grinding process, a fine-grinding process, a lapping process and/or a polishing process may be accomplished, depending on the desired surface finish.

German Patent Reference 101 34 198.9, the priority document corresponding to this invention, and its teachings are incorporated, by reference, into this specification.

1. A method for producing glass balls, comprising:
feeding a glass flow (11) in a flow direction between two rollers (20.1; 20.2) driven synchronously and counter-rotatingly from a feed tank (10) containing a mass of molten glass, each of the rollers (20.1; 20.2) having hemispherical depressions (21) distributed over a circumference and forming spherical beads (12) on a thin glass strip (13) successively near an imaginary contact tangent;
fixing a thickness of the glass strip (13) determined by a spacing between the rollers (20.1; 20.2) externally of the depressions (21) near the contact tangent;
separating crude balls (14) from the glass strip (13) using a separating device, once the glass strip (13) containing the spherical beads (12), is cooled; and
subjecting the crude balls (14) to a cold surface finishing treatment.

2. In the method according to claim 1, wherein the glass strip (13), between the spherical beads (12), forms intended breaking locations each having a thickness of about 1.5 mm.

3. In the method according to claim 2, wherein the rollers (20.1; 20.2) are heated to about 270 to 300° C. by radiation heat.

4. In the method according to claim 3, wherein the glass flow (11) is supplied to the rollers (20.1; 20.2) from the feed tank (10) at a temperature of between 1000 and 1200° C. and a viscosity of between 1 and 50 dPas at a through flow rate of between 200 and 250 g/min.

5. In the method according to claim 4, wherein the rollers (20.1; 20.2) have a diameter of between 100 and 250 mm and the depressions (21) have a radius of between 3 and 10 mm.

6. In the method according to claim 5, wherein the depressions (21) are positioned in circumferential rows on the roller surfaces with uniform spacings therebetween, and the adjacent circumferential rows are interleaved with each other so as to be offset from each other by a half of a spacing.

7. In the method according to claim 1, wherein the rollers (20.1; 20.2) are heated to about 270 to 300° C. by radiation heat.

8. In the method according to claim 1, wherein the glass flow (11) is supplied to the rollers (20.1; 20.2) from the feed tank (10) at a temperature of between 1000 and 1200° C. and a viscosity of between 1 and 50 dPas at a through flow rate of between 200 and 250 g/min.

9. In the method according to claim 1, wherein the rollers (20.1; 20.2) have a diameter of between 100 and 250 mm and the depressions (21) have a radius of between 3 and 10 mm.

10. In the method according to claim 1, wherein the depressions (21) are positioned in circumferential rows on the roller surfaces with uniform spacings therebetween, and the adjacent circumferential rows are interleaved with each other so as to be offset from each other by a half of a spacing.

11. An apparatus for producing glass balls comprising: a supply of a glass flow (11) from a feed tank (10), containing a mass of molten glass, to a shaping device having two rollers (20.1; 20.2) driven synchronously and counter-rotatingly, the rollers (20.1; 20.2) having hemispherical depressions (21) forming a thin glass strip (13) having spherical beads (12), a separating device (15) for separating the beads (12) from the glass strip (13) as crude balls (14) once the glass for strip (13) is cooled; and a cold surface finishing treatment apparatus for treating the crude balls.
